(19) United States
(12) Patent Application Publication
(10) Pub. No.: US 2016/0145831 A1
(43) Pub. Date: May 26, 2016

(54) A PIPELINE PADDER

(71) Applicant: MURPHY PIPE & CIVIL IP PTY LTD, Albion, Queensland (AU)

(72) Inventor: Thomas Robert DERMODY, New Farm, Queensland (AU)

(73) Assignee: Murphy Pipe & Civil IP PTY LTD, Queensland (AU)

(21) Appl. No.: 14/902,025

(22) PCT Filed: Jul. 3, 2014
(86) PCT No.: PCT/AU2014/000690

§ 371 Date: Dec. 30, 2015

(30) Foreign Application Priority Data
Jul. 3, 2013 (AU) 2013902493

(51) Int. Cl. E02F 5/22; E02F 7/00; F16L 1/028; F16L 3/26; F16L 1/06; F16L 1/024

(52) U.S. Cl. CPC E02F 5/226; F16L 1/06; F16L 1/0243; F16L 1/028; F16L 3/26; E02F 5/223; E02F 7/00

(57) ABSTRACT

A pipeline padder comprising: a storage unit including a hopper for storing particulate material and a storage conveyor to remove particulate material from the hopper; a loading unit including a loading conveyor to load particulate material into the hopper; a discharge unit including a discharge conveyor for discharging particular material supplied by the storage conveyor; and a locomotion unit to move the storage unit.

### FIELD OF THE INVENTION

This invention relates to a pipeline padder. In particular the invention relates to a pipeline padder that is able to cover pipes with sand. However it should be appreciated that the pipeline padder may be used with other particulate materials such as gravel, blue metal or other aggregates.

### BACKGROUND OF THE INVENTION

Pipelines are integral to most countries infrastructure. The technology surrounding the laying of pipes has increased dramatically over the years. This increase in technology has enabled pipes made of various materials to be laid very quickly. Accordingly it has been necessary to develop technology that enables pipes that have been laid to also be covered quickly and without damage. This has led to the development of pipeline padders.

Pipeline padders are used to deliver particulate material to cover pipes both quickly and accurately. Some pipeline padders have been developed that screen the materials that have been excavated to form a trench in which the pipeline has been laid. This type of pipeline padder scoops up the excavated materials, then screens the excavated material removing the larger material and then delivers the screened material remaining back into the trench to cover the pipeline safely. However, in many instances, the specification of the pipeline does not allow the material that has been excavated from the trench to be redelivered on top of the pipes. Therefore these types of pipeline padders are unable to be used when specific material, such as sand, is specified to cover pipes within the pipeline.

When material such as sand is required to be used to cover the pipes, the sand typically needs to be transported from a remote location to site. When the sand arrives at site, the sand is usually dumped in piles adjacent to the trench and then moved by excavators onto the pipes. This is a very time consuming process.

As an alternative, trucks have been converted into pipeline padders to deliver particulate material. Unfortunately these pipeline padders are unable to transport a large amount of particular material and the conveyor systems are often too light. Further, if the particulate material is located in a remote location, a large number of vehicles are required to keep pace with the laying of pipe. This is a large capital cost that may not be able to be recuperated in subsequent operations.

The reference to any prior art in this specification is not, and should not be taken as, an acknowledgement or any form of suggestion that the prior art forms part of the common general knowledge.

### OBJECT OF THE INVENTION

It is an object of the invention to overcome and/or alleviate one or more of the above disadvantages and/or provide the consumer with a useful or commercial choice.

### SUMMARY OF THE INVENTION

In one form not necessarily the only or broadest form, the invention resides in a pipeline padder comprising:

a storage unit including a hopper for storing particulate material and a storage conveyor to remove particulate material from the hopper;

a loading unit including a loading conveyor to load particulate material into the hopper;

a discharge unit including a discharge conveyor for discharging particular material supplied by the storage conveyor; and

a locomotion unit to move the storage unit.

The hopper typically has a pair of sidewalls and a pair of end walls. The side walls are typically inclined. The sidewalls may be inclined at an angle between 40 to 50 degrees. Preferably the sidewalls have an inclination of 45 degrees. An exit may be located in one of the end walls. The hopper may have an open top. A catcher may be located on the hopper.

One or more walkways may be located on the outside of the hopper. A control device may be located on the outside of the hopper. The control device may be accessible via a walkway. A remote control device can also be used for better accuracy of placing particulate on top of the pipes. A remote control can also provide more visibility.

A vibration device may be located on the hopper. The vibration device may be operated when there is build up of particular matter on the walls of the hopper.

The storage conveyor may form a base of the hopper. The storage conveyor may extend at least the length of the hopper. Typically the storage conveyor extends through the exit.

The storage conveyor is normally a flat belt conveyor. However it should be appreciated that the storage conveyor may be either a V-belt or trough belt conveyor.

A metering device may be associated with the exit. The metering device may be used to vary the size of the exit. Typically the metering device includes a metering wall that can be raised or lowered.

The loading conveyor is typically a trough conveyor. The loading conveyor is normally angled between 25 and 35 degrees. Preferably the loading conveyor is angled at approximately 30 degrees.

The loading conveyor may be supported by support wheels. The support wheels are normally located adjacent an end of the loading conveyor.

The loading unit may include a delivery device that delivers sand onto the loading conveyor. The delivery device may be used to catch particular material that is delivered from trucks that carry particular material.

The delivery device may include one or more delivery conveyors that deliver particular material onto the loading conveyor. Normally there are two delivery conveyors. A delivery conveyor may be mounted onto each side of the loading conveyor to move particular material toward the loading conveyor.

The delivery device may include a support frame. The frame is typically used to mount the delivery conveyors. The frame may also form a crash barrier for vehicles delivering sand into the delivery device. At least one roller may be located on the frame. The roller may enable the wheels of a vehicle to spin the crash rollers if the wheels contact the delivery device.

The loading unit is able to be moved between an operational position in which the loading unit is able to load particular matter into the hopper and a transport position in which the loading unit located on the hopper.

The discharge conveyor may be extended transversely with respect to a longitudinal axis of the hopper. The discharge conveyor may be moved transversely with respect to the hopper.

A discharge conveyor drive may be used to move the discharge conveyor. The discharge charge conveyor drive may include a at least one rack and at least one pinion. However, it should be appreciated that other drives known in the art would be suitable. The height of the discharged conveyor may be varied. A height adjustment mechanism may be used for this purpose.

The discharge unit may include a discharge storage conveyor mount to mount the discharge conveyor. The height of the discharge storage conveyor mount maybe be varied with respect to the storage conveyor. A height adjustment mechanism that is attached to the discharge storage conveyor mount may be used for this purpose.

A splitting device may be located adjacent an end of the discharge conveyor to split the particular material into different streams. The splitter device may form part of a hood that is located adjacent the end of the discharge conveyor.

The discharge conveyor may be moved between an operational position in which the delivery conveyor is substantially flat to a transport position in which the discharge conveyor is folded.

The locomotion unit is typically located adjacent the storage unit. The locomotion unit normally includes a pair of tracks. However it should be appreciated that any rotational device such as wheels may be utilised.

A remote control unit may operate the locomotion unit, storage unit, loading unit or discharge unit. Typically the remote control unit can operate the storage unit, loading unit, discharge unit and locomotion unit.

### BRIEF DESCRIPTION OF THE DRAWINGS

An embodiment of the invention, by way of example only, will now be described with reference to the accompanying drawings in which:

FIG. 1 is a perspective view of a pipeline padder in an operation position according to an embodiment of the invention;

FIG. 2 is a further perspective view of a pipeline padder according to FIG. 1;

FIG. 3 is a perspective view of a discharge unit according to an embodiment of the invention;

FIG. 4 is a perspective view of a discharge conveyor and associated hood according to an embodiment of the invention;

FIG. 5A is a perspective view of a the discharge conveyor mount in a downward position according to an embodiment of the invention;

FIG. 5B is a perspective view of a the discharge conveyor mount in a upward position according to an embodiment of the invention;

FIG. 6 is a perspective view of a discharge conveyor in a transport position according to an embodiment of the invention;

FIG. 7 is a perspective view of a pipeline padder in a transport position according to an embodiment of the invention; and

FIG. 8 is a perspective view of a pipeline padder in an operation position with a catcher.

### DETAILED DESCRIPTION OF THE PREFERRED EMBODIMENT

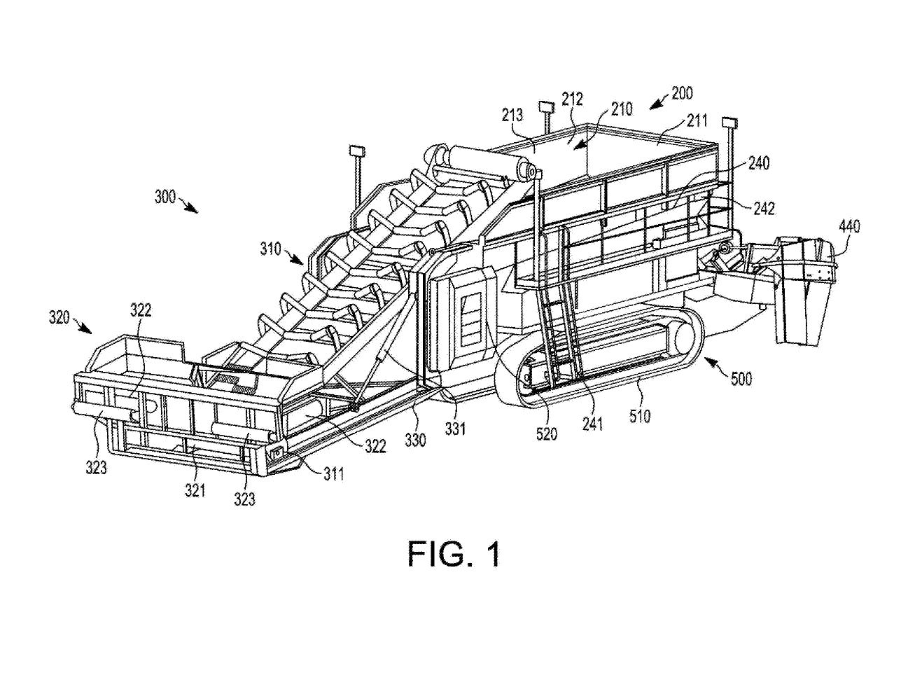

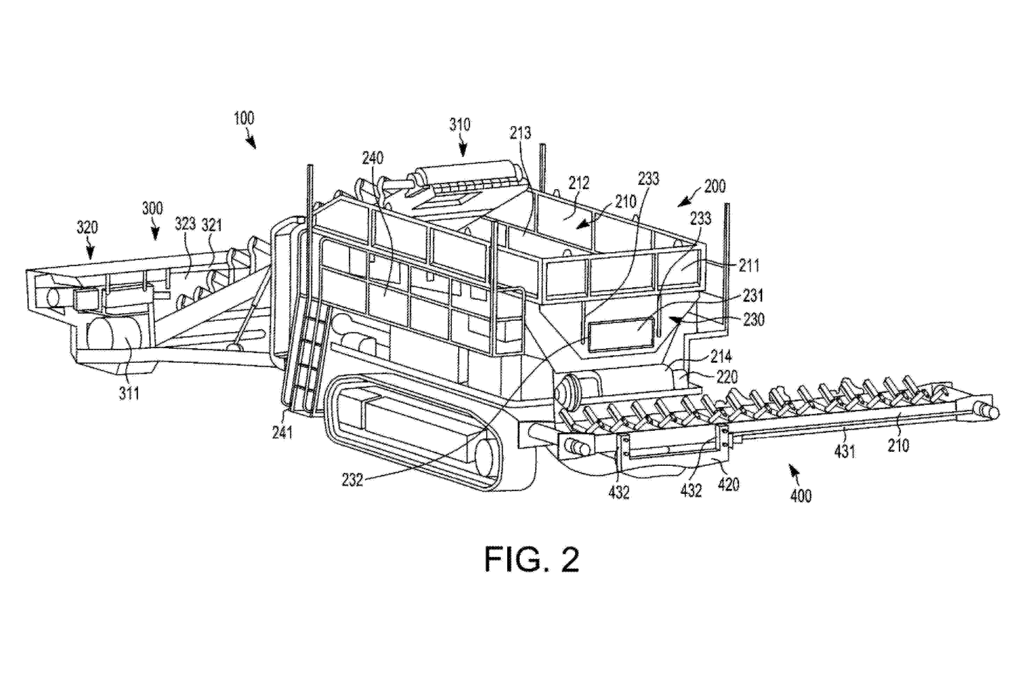

FIGS. 1 and 2 shows a pipeline padder 100 that it used to deliver fine particular materials such as sand into a trench to cover a pipeline. The pipeline padder 100 includes a storage unit 200, a loading unit 300, a discharge unit 400 and a locomotion unit 500.

The storage unit 200 includes a hopper 210 and a storage conveyor 220. The hopper 210 is used to store particular material such as sand. The hopper 210 includes two end walls 211 and two side walls 212. The two side walls 212 have a portion of the side wall 212 which is inclined. The inclination of the side wall 212 is approximately at 45 degrees. Both end walls 211 are substantially parallel to each other. The hopper has an open top 213. An exit 214 is located in an end wall 211 of the hopper 210.

The storage conveyor 220 forms the base of the hopper 210. Any particulate material that is located within the hopper 210 will slide down the inclined side walls 212 and sit on top of the storage conveyor 220. The storage conveyor 220 is a flat belt conveyor. The storage conveyor 220 extends the length of the hopper through the exit 214.

A metering device 230 is located over the exit 214 in the end wall 211 of the hopper 210. The metering device 230 is used to meter the amount of particulate material that flows from the hopper 210 dependent on the speed of the storage conveyor 220. The metering device 230 includes a metering wall 231 which is mounted within a pair of tracks 232. Pair of metering hydraulic rams 233 are used to move the metering device 230 to vary the size of the exit.

A walk way 240 is located on each of the sides of the hopper 210. A ladder 241 is associated with each walk way 240 so that a user is able to access the walkway. A control unit 242 is located on the side of the hopper and can be accessed via a walkway 240.

A number of vibration devices (not shown) are located on the side walls 212 of the hopper 210. These vibration devices are used to vibrate the side walls 212 of the hopper 210 to dislodge any excess particulate material that has built up on the side walls 212 of the hopper 210.

The loading unit 300 is used to load particulate material into the hopper 210. The loading unit 300 is located at one end of the hopper 210. The loading unit 300 includes a loading conveyor 310 that extends from close to ground level to above the open top of the hopper 210. The loading conveyor 310 is a trough conveyor and is angled at approximately 30 degrees. Two support wheels 311 are used to support an end of the loading conveyor. The support wheels 311 contact the ground and follow the contours of the ground as the pipeline padder 100 moves along the ground.

The loading unit 300 also includes a delivery device 320 that is mounted above the loading conveyor 310. The delivery device 320 is used to deliver particulate onto the loading conveyor 310. The delivery device 320 includes a support frame 321 which is used to support two delivery conveyors 322. The delivery conveyors 322 are spaced apart so that there is a delivery aperture located between the delivery conveyors 322 for the delivery of particulate material from the delivery conveyors 322 onto the loading conveyor 310. The support frame 321 also provides a crash barrier for vehicles that are loading particulate into the delivery device 320. Two rollers 323 are located on the support frame 321 to enable vehicle tires to touch the delivery device 320 without substantially damaging the delivery device 320. The delivery device 320 can be removed and attached to the loading conveyor 310 as is required.

The loading unit 300 also includes a lifting arm 330 which extends from adjacent a lower end of the loading conveyor 310 to a bottom of the storage unit 200. The lifting arm 330 is pivotally connected to the storage unit 200. A lifting ram 331 is pivotally attached to adjacent a top of the storage unit 200 and also pivotally attached to the lifting arm 330 at a position spaced away from the storage unit 200.

The discharge unit 400 is used to distribute particulate material that is discharged from the hopper 210 by the storage conveyor 220. The discharge unit 400 is located at an opposite end of the hopper 210 to that of the loading unit 300. The discharge unit 400 includes a discharge conveyor 410 that is located below the exit 214 of the hopper 210 when in use. The discharge conveyor 410 is a trough conveyor that it orientated transversely with respect to the storage conveyor 210. The discharge conveyor 410 is mounted on a discharge storage conveyor mount 420.

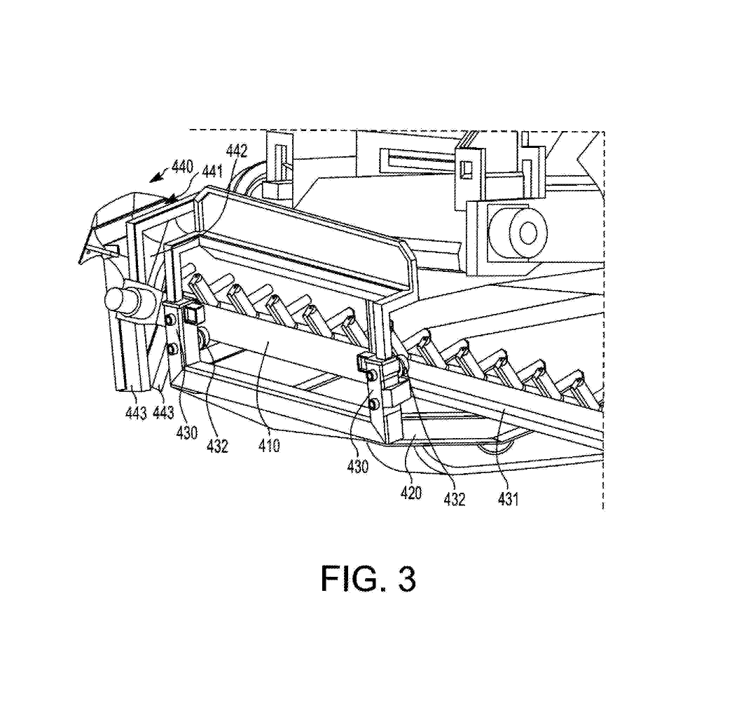

The discharge conveyor 410 can be moved transversely with respect to the hopper 210. That is, the discharge conveyor 410 can be moved so that particulate material can be delivered into a trench containing a pipeline that is spaced a distance away from the storage unit 200. The discharge conveyor 410 is able to be moved to either side of the hopper 210 using a discharge charge conveyor drive 430 as shown more clearly in FIG. 3.

The discharge charge conveyor drive 430 includes two racks 431 that are mounted on respective sides of the discharge conveyor 410. Driven pinion wheels 432 are located on the discharge storage conveyor mount and engage the racks. Rotation of the driven pinions wheel 432 which engage respective racks 431 cause the discharge conveyor 410 to move transversely with respect to the hopper 210.

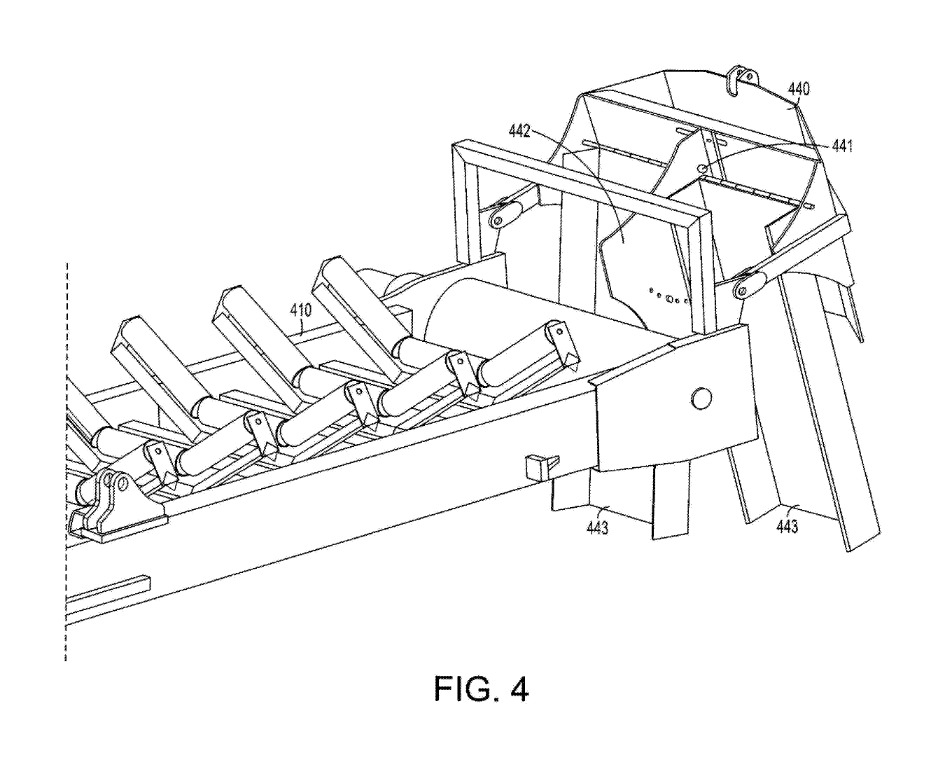

A hood 440 is located at each end of the discharge conveyor 410 shown more clearly in FIG. 4. The hood 440 is used to distribute particulate material that passes from the delivery conveyor 410 into the trench. The hood 440 is pivotally mounted to the discharge conveyor 410 so that the angle of the hood 440 can be varied with respect to the discharge conveyor 410. A pivoting ram (not shown) is connected to the hood 440 and to the discharge conveyor 410 to pivot the hood with respect to the discharge conveyor 410.

A splitter device 441 forms part of each of the hoods 440. The splitter device 441 includes a central member 442 which splits the particulate material that passes from the discharge conveyor 410 into two separate material flows on each side of the central member 442. Two deflection members 443 located on each side of the central member 442 deflect particulate material into the trench at different angles. Each of these deflection members 443 is in the form of a U shaped channel. However, it should be appreciated that the deflection devices 443 could be of other shapes and forms.

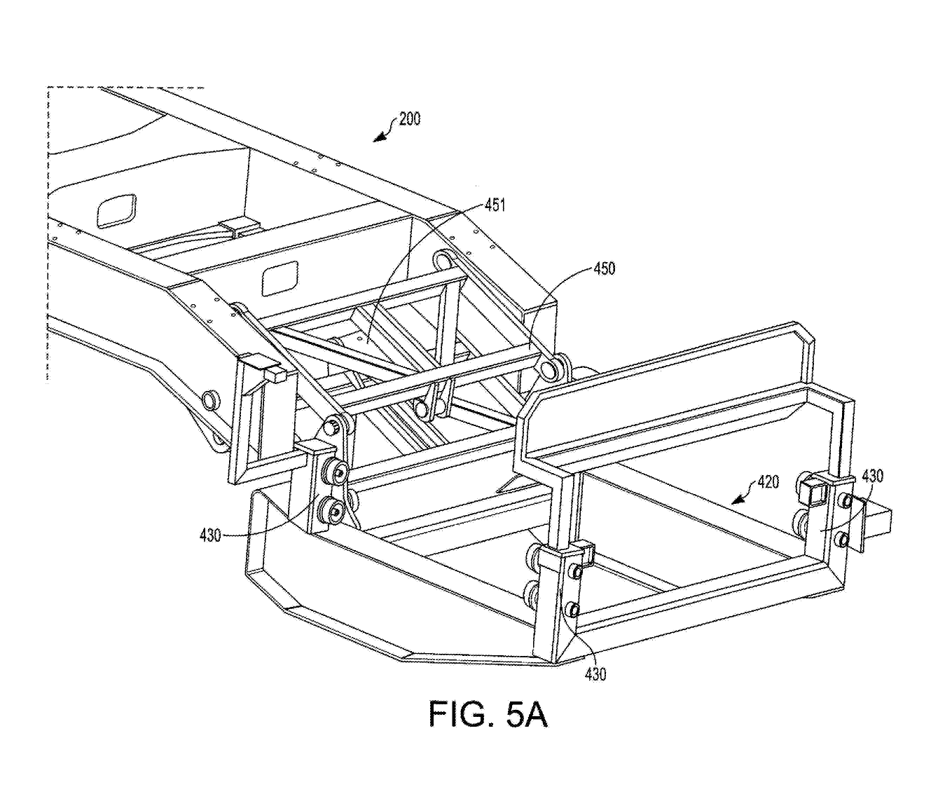

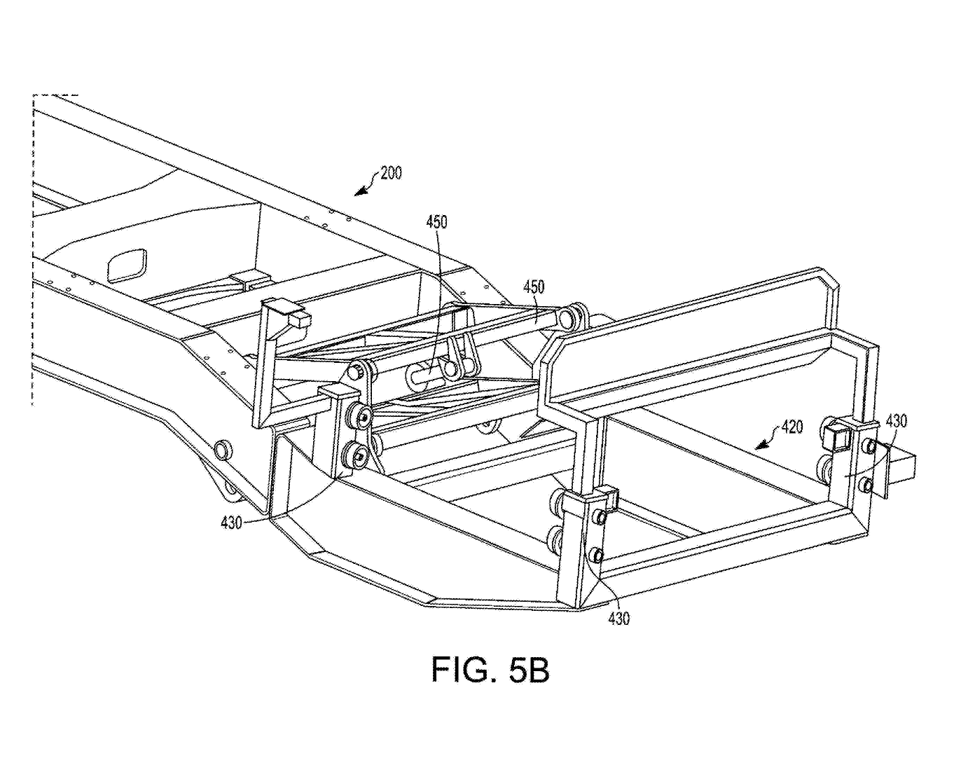

The discharge storage conveyor mount 420 is connected to the storage unit 200 via a lifting assembly 450 as shown in FIGS. 5A and 5B. The lifting assembly 450 is in the form of a scissor mechanism. A lifting ram 451 is centrally located within the lifting assembly 450. An extension of the lifting ram 450 causes the lifting assembly to move the discharge storage conveyor mount 420 downwardly as shown in HG 5A whilst retraction of the lifting ram causes 451 the lifting assembly 450 to move the discharge storage conveyor mount 420 upwardly as shown in FIG. 5B. Accordingly, the lifting assembly 450 enables the height of the discharge conveyor 410 to be varied with respect to the exit 214. It would be appreciated that the lifting assembly 450 maybe of a different form.

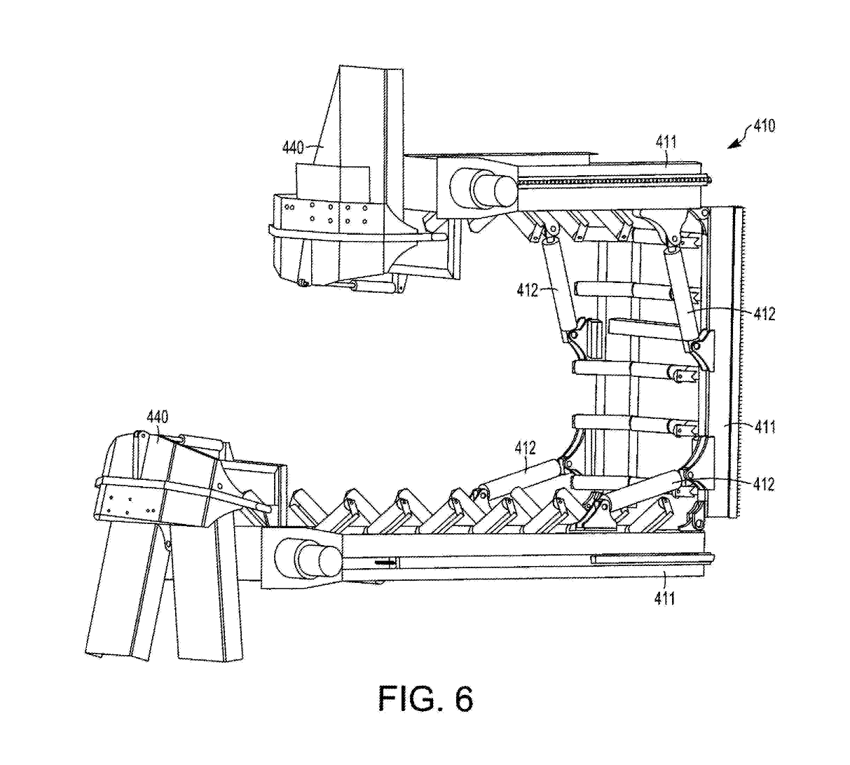

The discharge conveyor 410 shown in more detail in FIG. 6, is split into three separate sections 411 with each section 411 being pivotally connected to an adjacent section 411. Two pivotally rams 412 extend between each adjacent section 411. Extension of the pivotally rams 412 enables the discharge conveyor to be substantially flat. This is the discharge conveyors 410 operational position. Retraction of each of the pivotally rams 412 causes each section to be angled with respect to each adjacent section. This is the discharge conveyors 410 transport position.

The locomotion unit 500 is located adjacent the storage unit and is used to move the pipeline padder 100. The locomotion unit 500 includes two tracks 510 that are driven by one or more associate hydraulic motors 520. These motors 520 are also used to drive the loading conveyor 310, storage conveyor 220 and discharge conveyor 410. The hydraulic motors 520 are also used to drive all of the rams located on the pipeline padder 100. The control unit 242 located on the hopper 210 is used to control the functions of the pipeline padder 100. As an alternative, a remote control unit (not shown) can be used to control the functions of the pipeline padder 100.

In use, a vehicle carrying particulate material is located adjacent to the delivery device 320. The vehicle unloads particulate material from the vehicle into the delivery device 320. The delivery conveyors 322 rotate towards each other so that any particulate material that contacts them is pushed toward the delivery aperture 323. Particulate material then passes onto the loading conveyor 310 which transports the particulate material into the hopper 210. The storage conveyor 220 is then operated to deliver particulate material from the hopper 210 onto the discharge conveyor 410 via the exit 214 in the hopper 210. The particulate material on the discharge conveyor 410 is pitched into one of the two hoods 440. The particulate material is split into discrete flows by the splitter device 441 and is delivered onto different sides of a pipe located within a trench.

Typically, the pipeline padder 100 is operated continuously whilst a vehicle is unloading particulate material into the delivery device. That is, the pipeline padder 100 is moving whilst unloading is occurring. The crash rollers 323 on the frame of the delivery device provide a safe guard for operators of a vehicle if they misjudge the speed of the pipeline padder 100 and the wheels of the vehicle touch the support frame 321

It should be appreciated that the loading conveyor 310, storage conveyor 220 and discharge conveyor 410 can be operated independently. For example, a vehicle can deliver particulate material into the discharge device 320 which passes onto the loading and into the hopper 210 to fill the hopper 210 with particulate whilst the storage conveyor 220 and discharge conveyor 410 are not operational. Similarly, particulate material can be discharged from the hopper 210 using the storage conveyor 220 and discharge conveyor 410 without the loading conveyor 310 needing to be operated.

The discharge conveyor 410 can move from side to side to deliver particulate material to either side of the hopper 210. This is often required if there are two trenches and two pipelines being laid simultaneously.

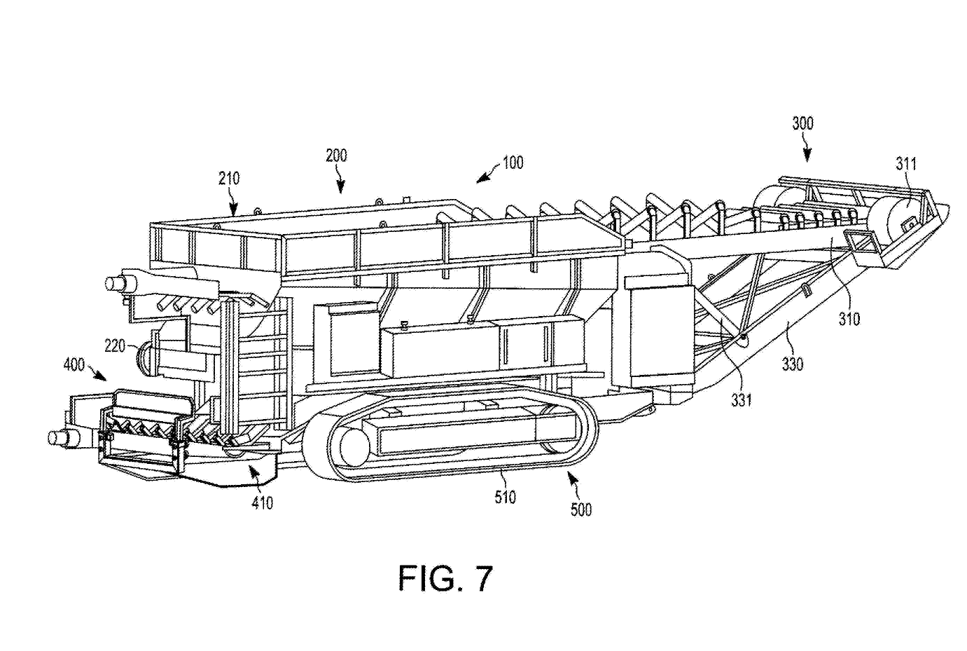

When the pipeline padder 100 is to be moved from one location to another, it is necessary to load the pipeline padder 100 onto a transport vehicle. In most countries throughout the world, the length and width dimensions of the pipeline padder 100 do not allow the pipeline padder being transported in its operational position. Accordingly, when transportation of the pipeline padder 100 is needed, modification of the pipeline padder is required by moving the lifting loading conveyor 210 and the discharge conveyor from their operational positions to their transport positions as shown in FIG. 7. This modification occurs by first removing the delivery device 320 from the front of the loading conveyor 310. The lifting ram 331 is retracted so that the loading conveyor 310 is lifted to a substantially horizontal position as well as slid forward to extend further over the hopper 210. Once this has been completed, the loading conveyor 310 is in its transport position. The pivotally rams 412 on the discharge conveyor 410 are retracted so that each of the sections 411 are substantially perpendicular with respect to adjacent sections 411. That is, the discharge conveyor 410 will form C-shape once the discharge conveyor is in its transport position. The pipeline padder 100 can then be loaded onto a transport vehicle to transport the pipeline padder 100.

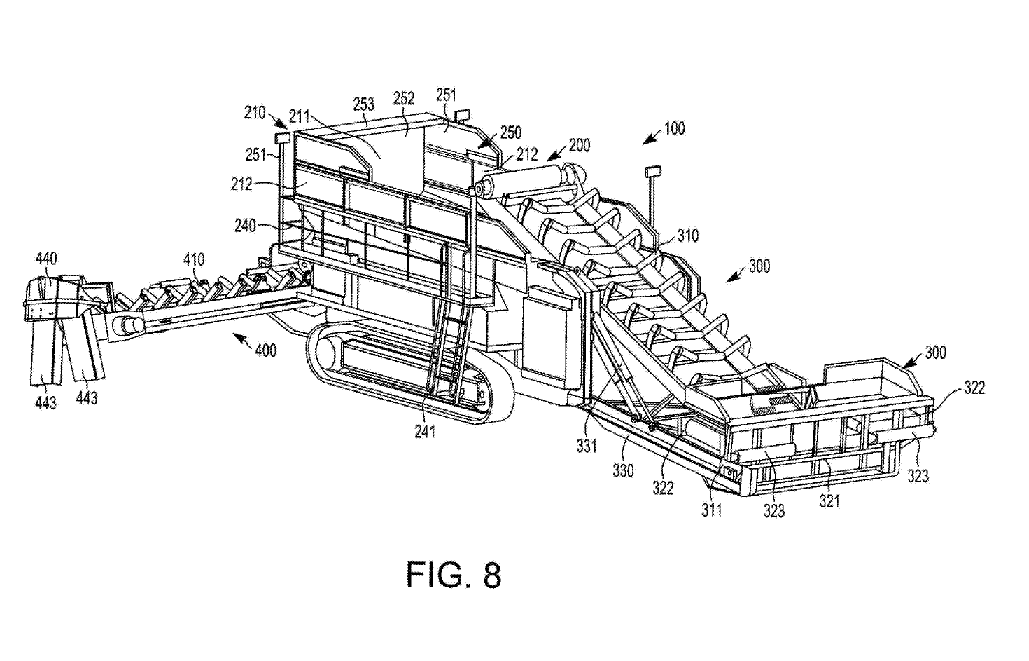

FIG. 8 shows the pipeline padder 100 having a catcher 250 attached to the hopper 210. The catcher 250 assists in preventing particulate material from passing over the top of the hopper 210 after it passes from the loading conveyor 310. The catcher 250 has two catcher sides 251, a catcher end 252 and a catcher top 252. The catcher 250 sits on top of the hopper 210 so that the two catcher sides 251 contact the hopper side walls 212 and the catcher end 252 contacts the hopper end wall 211. The catcher 250 is located at one end hopper 210 opposite the loading conveyor 310.

In this specification, the terms “comprise”, “comprises”, “comprising” or similar terms are intended to mean a non-exclusive inclusion such that a system, method or apparatus that comprises a list of elements does not include those elements solely, but may well include other elements not listed.

It should be appreciated that various other changes modifications may be made to the embodiment described with that departed from the spiritual scope of the invention.

What is claimed is:

1. A pipeline padder comprising:
a storage unit including a hopper for storing particulate material and a storage conveyor to remove particulate material from the hopper;
a loading unit including a loading conveyor to load particulate material into the hopper;
a discharge unit including a discharge conveyor for discharging particular material supplied by the storage conveyor; and
a locomotion unit to move the storage unit.

2. The pipeline padder of claim 1 wherein the hopper includes a pair of sidewalls and a pair of end walls.

3. (canceled)

4. The pipeline padder of claim 2 wherein an exit is located in one of the end walls.

5. The pipeline padder of claim 1 wherein the hopper has an open top.

6. (canceled)

7. (canceled)

8. (canceled)

9. The pipeline padder of claim 1 wherein a vibration device is located on the hopper.

10. The pipeline padder of claim 4 wherein the storage conveyor forms a base of the hopper.

11. (canceled)

12. The pipeline padder of claim 10 wherein the storage conveyor extends through the exit.

13. (canceled)

14. The pipeline padder of claim 2 wherein a metering device is associated with the exit.

15. (canceled)

16. The pipeline padder of claim 14 wherein the metering device includes a metering wall that can be raised or lowered.

17. (canceled)

18. The pipeline padder of claim 1 wherein the loading conveyor is supported by support wheels.

19. (canceled)

20. The pipeline padder of claim 1 wherein a delivery device is located adjacent the loading conveyor, the delivery device including one or more delivery conveyors for delivering particular material onto the loading conveyor.

21. (canceled)

22. (canceled)

23. The pipeline padder of claim 20 wherein the delivery device includes a support frame to mount the delivery conveyors.

24. (canceled)

25. The pipeline padder of claim 23 wherein the delivery conveyor is mounted onto each side of the loading conveyor to move particular material toward the loading conveyor.

26. The pipeline padder of claim 1 wherein the loading unit is moveable between an operational position in which the loading unit is able to load particular matter into the hopper and a transport position in which the loading unit is located on the hopper.

27. The pipeline padder claim 1 wherein the discharge conveyor extends transversely with respect to a longitudinal axis of the hopper.

28. The pipeline claim 1 wherein the discharge conveyor is moved transversely with respect to the hopper.

29. (canceled)

30. (canceled)

31. The pipeline padder of claim 1 wherein the discharge conveyor includes a height adjustment mechanism to vary the height of the discharge conveyor

32. The pipeline padder of claim 1 wherein the discharge unit includes a discharge storage conveyor mount to mount the discharge conveyor.

33. (canceled)

34. The pipeline padder of claim 1 wherein a splitter device is located adjacent an end of the discharge conveyor to split the particular material into different streams.

35. The pipeline padder of claim 34 wherein the splitter device forms part of a hood that is located adjacent an end of the discharge conveyor.

36. The pipeline padder of claim 1 wherein the discharge conveyor is moved between an operational position in which the delivery conveyor is substantially flat to a transport position in which the discharge conveyor is folded.

37. The pipeline padder of claim 1 wherein the locomotion unit is located adjacent the storage unit.

38. The pipeline padder of claim 1 wherein the locomotion unit normally includes a pair of tracks.

39. (canceled)

40. (canceled)
